(19) United States
(12) Patent Application Publication
(10) Pub. No.: US 2023/0319916 A1
(43) Pub. Date: Oct. 5, 2023

(54) 5G PROSE PC5 OPERATIONS BASED ON NETWORK PROCEDURES

(71) Applicant: Samsung Electronics Co., Ltd., Suwon-si (KR)

(72) Inventors: Mahmoud WATFA, Staines (GB); Mehrdad SHARIAT, Staines (GB)

(21) Appl. No.: 18/191,489

(22) Filed: Mar. 28, 2023

(30) Foreign Application Priority Data
Mar. 29, 2022 (GB) 2204500.9
May 4, 2022 (GB) 2206527.0
May 17, 2022 (GB) 2207225.0
Mar. 16, 2023 (GB) 2303876.3

(51) Int. Cl. H04W 76/14; H04W 28/02; H04W 48/18

(52) U.S. Cl. CPC H04W 76/14; H04W 28/0289; H04W 48/18; H04W 92/18

(57) ABSTRACT

The disclosure relates to a 5G or 6G communication system for supporting a higher data transmission rate. A method, for a first user equipment (UE) in a network including the first UE and a second UE, wherein the first UE is configured to operate as a relay node between the second UE and the network is provided. The method includes receiving, from the second UE, a first message to request establishment of a direct link between the second UE and the first UE, and if a certain condition is satisfied, sending, to the second UE a second message rejecting the request, wherein the condition includes the request is for relaying, congestion control is activated at the first UE, a relay service code (RSC) included in the first message corresponds to a data network name (DNN), and the first UE, to meet the request, needs to perform a protocol data unit (PDU) session establishment procedure for the DNN and/or S-NSSAI.

### CROSS-REFERENCE TO RELATED APPLICATION(S)

This application is based on and claims priority under 35 U.S.C. § 119(a) of a United Kingdom patent application number 2204500.9, filed on Mar. 29, 2022, in the United Kingdom Intellectual Property Office, of a United Kingdom patent application number 2206527.0, filed on May 4, 2022, in the United Kingdom Intellectual Property Office, of a United Kingdom patent application number 2207225.0, filed on May 17, 2022, in the United Kingdom Intellectual Property Office, and of a United Kingdom patent application number 2303876.3, filed on Mar. 16, 2023, in the United Kingdom Intellectual Property Office, the disclosure of each of which is incorporated by reference herein in its entirety.

### BACKGROUND

### 1. Field

The disclosure relates to methods, apparatus and systems for 5th generation (5G) ProSe PC5 operations based on network procedures.

### 2. Description of Related Art

5G mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with eXtended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide methods, apparatus and systems for fifth generation (5G) ProSe PC5 operations based on network procedures.

Additional aspects will be set forth in part in the description which follows and, in part, will be apparent from the description, or may be learned by practice of the presented embodiments.

In accordance with an aspect of the disclosure, a method performed by a first user equipment (UE) in a network is provided. The method includes receiving, from a second UE in the network, a first message to request establishment of a direct link between the second UE and the first UE, wherein the first UE is configured to operate as a relay node between the second UE and the network, and in cast that a certain condition is satisfied, sending, to the second UE, a second message rejecting the request, wherein the certain condition includes the request is for relaying, and congestion control is activated at the first UE.

In accordance with another aspect of the disclosure, a method performed by a first UE in a network is provided. The method includes receiving, from a second UE in the network, a first message to request modification of a direct link between the second UE and the first UE, wherein the first UE is configured to operate as a relay node between the second UE and the network, and in case that a certain condition is satisfied, sending, to the second UE, a second message rejecting the request, wherein the certain condition includes the first UE cannot support the addition of one or more packet filters required to perform a link modification operation for satisfying the request.

In accordance with another aspect of the disclosure, a first user equipment (UE) in a network is provided. The UE includes a transceiver, and a processor coupled with the transceiver and configured to receive, from a second UE in the network, a first message to request establishment of a direct link between the second UE and the first UE, wherein the first UE is configured to operate as a relay node between the second UE and the network, and in cast that a certain condition is satisfied, send, to the second UE, a second message rejecting the request, wherein the certain condition includes the request is for relaying, and congestion control is activated at the first UE.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 illustrates how a 5G ProSe UE-to-Network Relay UE serves a remote UE according to the related art;

FIG. 2 illustrates 5G ProSe communication via 5G ProSe Layer-3 UE-to-Network Relay without non-3GPP interworking function (N3IWF) according to the related art;

FIG. 3 is a block diagram of a network entity that may be used in certain examples according to an embodiment of the disclosure;

FIG. 4 illustrates an electronic device according to an embodiment of the disclosure; and

FIG. 5 illustrates a base station according to an embodiment of the disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

The same or similar components may be designated by the same or similar reference numerals, although they may be illustrated in different drawings.

Throughout the description and claims of this specification, the words “comprise”, “include” and “contain” and variations of the words, for example “comprising” and “comprises”, means “including but not limited to”, and is not intended to (and does not) exclude other features, elements, components, integers, steps, processes, operations, functions, characteristics, properties and/or groups thereof.

For example, reference to “an object” includes reference to one or more of such objects.

Throughout the description and claims of this specification, language in the general form of “X for Y” (where Y is some action, process, operation, function, activity or step and X is some means for carrying out that action, process, operation, function, activity or step) encompasses means X adapted, configured or arranged specifically, but not necessarily exclusively, to do Y.

Features, elements, components, integers, steps, processes, operations, functions, characteristics, properties and/or groups thereof described or disclosed in conjunction with a particular aspect, embodiment, example or claim of the disclosure are to be understood to be applicable to any other aspect, embodiment, example or claim described herein unless incompatible therewith.

Herein, the following documents are referenced:

[1] 3^{rd} generation partnership project (3GPP) technical specification (TS) 23.304 V0.2.0

[2] 3GPP TS 24.501 V17.5.0

[3] 3GPP TS 24.554 V17.0.0

Various acronyms, abbreviations and definitions used in the disclosure may be defined as below.

N1 mode a mode of a UE allowing access to the 5G core network via the 5G access network

PC5 Direct communication link between capable ProSe UEs

S1 mode a mode of a UE that operates with a functional division that is in accordance with the use of an S1 interface between the radio access network and the core network

T Timer

Uu interface Air interface between terminal and base station/access point

Overview of 5G proximity services (ProSe)

ProSe enables direct communications between devices where these devices can engage in ProSe discovery and/or ProSe communications using so called PC5 resources.

One of the use cases of ProSe is to provide relay services to so called remote user equipment (UE). A remote UE is a UE that is not in direct coverage of the network, whereas a relay UE is in coverage of the network and hence acts as a communication relay for the remote UEs. A Layer 3 UE-to-Network relay UE provides connectivity for remote UEs by establishing a protocol data unit (PDU) session that is used for relay communication. More details about ProSe services can be found in TS 23.304 [1] amongst other specifications.

Normally, when at least one remote UE uses a Layer-3 UE-to-network relay, the latter will send a report to the network to indicate the number of remote UEs that are being served by the Layer-3 UE-to-network relay.

In general, all the 5G Session management (5GSM) procedures that are defined in TS 24.501 [2] would be applicable for the case of a Layer-3 UE-to-Network relay.

Hereafter, the term “relay UE” may refer to any suitable type of relay UE, for example a Layer-3 UE-to-network relay UE or a Layer-2 relay UE.

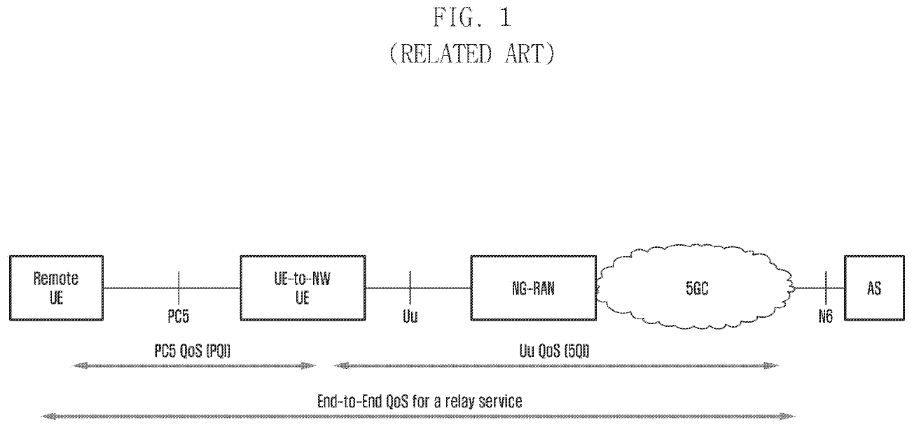

FIG. 1 illustrates how a 5G ProSe UE-to-Network Relay UE serves a remote UE according to the related art.

A Layer-3 UE-to-network relay UE provides connectivity to remote UEs for different types of PDU sessions, such as internet protocol (IP), Ethernet, or unstructured data. FIG. 1, from [1], shows how a 5G ProSe UE-to-Network Relay UE serves a remote UE according to the related art.

Summary of Congestion Control

When the network experiences congestion, the network applies some congestion control mechanisms such as providing back-off (BO) timers to the UE which prevent most signalling to be sent from the UE (with a few exceptions), until the BO timer expires or until the network sends a downlink message to the UE which signals the end of congestion. Most of the existing 5GSM procedures (in N1 mode, and evolved packet core (EPS) session management (ESM) procedures in S1 mode) are subject to BO timers. The type of BO timer that is provided by the network to the UE depends on the reason for congestion. For example, T3396 is provided to the UE when the network wants to control congestion on the data network name (DNN) level. Other BO timers include: T3584 which is related to slice and DNN level congestion, and T3585 which is related to slice level congestion. Note that a slice may be referred do by a network slice selection assistance information (single network slice selection assistance information, S-NSSAI) (see [2]).

Certain examples of the disclosure provide methods, apparatus and systems for 5G ProSe PC5 operations based on network procedures.

The following examples are applicable to, and use terminology associated with, 3GPP 5G. However, the skilled person will appreciate that the techniques disclosed herein are not limited to these examples or to 3GPP 5G, and may be applied in any suitable system or standard, for example one or more existing and/or future generation wireless communication systems or standards, including any existing or future releases of the same standards specification, for example 3GPP 5G.

The functionality of the various network entities and other features disclosed herein may be applied to corresponding or equivalent entities or features in other communication systems or standards. Corresponding or equivalent entities or features may be regarded as entities or features that perform the same or similar role, function, operation or purpose within the network.

The skilled person will appreciate that the disclosure is not limited to the specific examples disclosed herein. For example:

The techniques disclosed herein are not limited to 3GPP 5G.

One or more entities in the examples disclosed herein may be replaced with one or more alternative entities performing equivalent or corresponding functions, processes or operations.

One or more of the messages in the examples disclosed herein may be replaced with one or more alternative messages, signals or other type of information carriers that communicate equivalent or corresponding information.

One or more further elements, entities and/or messages may be added to the examples disclosed herein.

One or more non-essential elements, entities and/or messages may be omitted in certain examples.

The functions, processes or operations of a particular entity in one example may be divided between two or more separate entities in an alternative example.

The functions, processes or operations of two or more separate entities in one example may be performed by a single entity in an alternative example.

Information carried by a particular message in one example may be carried by two or more separate messages in an alternative example.

Information carried by two or more separate messages in one example may be carried by a single message in an alternative example.

The order in which operations are performed may be modified, if possible, in alternative examples.

The transmission of information between network entities is not limited to the specific form, type and/or order of messages described in relation to the examples disclosed herein.

Certain examples of the disclosure may be provided in the form of an apparatus/device/network entity configured to perform one or more defined network functions and/or a method therefor. Certain examples of the disclosure may be provided in the form of a system (e.g., a network) comprising one or more such apparatuses/devices/network entities, and/or a method therefor.

At least the following problems exist in view of the related art:

1. The Session Management Congestion Control is Currently not Considered for PC5 Connections

The following, from [1], describes how the mobility management congestion control impacts the PC5 link between a relay UE and a remote UE:

“The 5G ProSe UE-to-Network Relay may be subject to non access stratum (NAS) level congestion control, as specified in clause 5.19.7 of TS 23.501 [4].

Both 5G ProSe Layer-2 UE-to-Network Relays and Layer-3 UE-to-Network Relays, when NAS Mobility Management congestion control as specified in clause 5.19.7.2 of TS 23.501 [4] is activated, i.e., the 5G ProSe UE-to-Network Relay receives a Mobility Management back-off timer from the access and mobility management function (AMF), the 5G ProSe UE-to-Network Relay is not able to serve the 5G ProSe Remote UE after the 5G ProSe UE-to-Network Relay enters connection management (CM)_IDLE state. If the 5G ProSe UE-to-Network Relay has a Mobility Management back-off timer when it enters CM_IDLE state the 5G ProSe UE-to-Network Relay releases the PC5 connections with its 5G ProSe Remote UEs indicating it is temporarily not available, so the Remote UE can (re)select another 5G ProSe UE-to-Network Relay. The 5G ProSe UE-to-Network Relay does not perform UE-to-Network Relay Discovery as described in clause 6.3.2.3 and does not accept any PC5 connections for relaying until the back-off timer expires if the 5G ProSe UE-to-Network Relay is in CM_IDLE state.

A Remote UE may also be subject to NAS level congestion control as specified in TS 23.501 [4].”

From the above, it can be seen that when a back-off (BO) timer is running for congestion control on the mobility management level, the 5G ProSe UE-to-Network Relay UE releases the PC5 connections with the remote UEs.

However, the 5G ProSe UE-to-Network Relay UE may additionally be subject to congestion control on the session management level and in fact may not be able to execute required steps for serving a remote UE. It is not clear from existing procedures how the congestion control on the session management level for 5G ProSe UE-to-Network Relay can be supported.

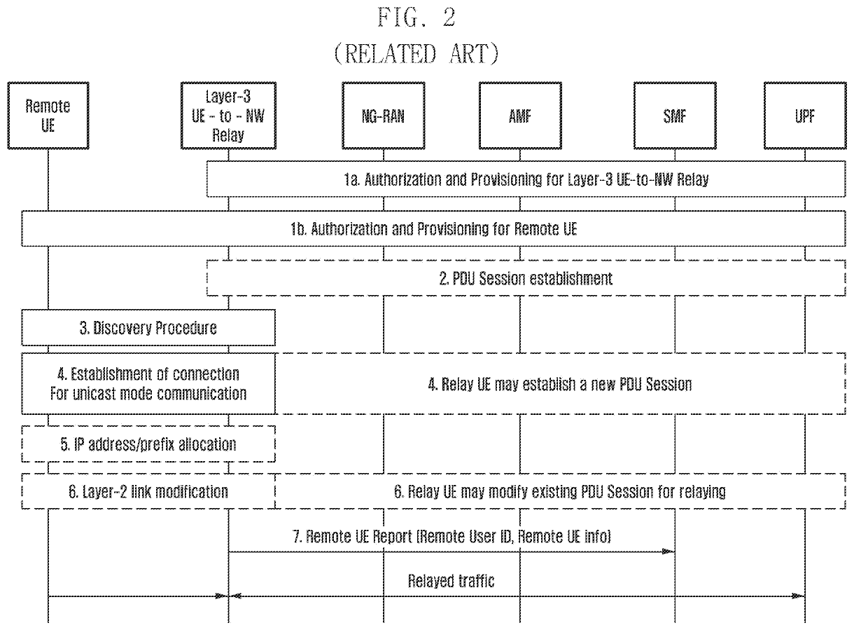

FIG. 2 illustrates 5G ProSe communication via 5G ProSe Layer-3 UE-to-Network Relay without non-3GPP interworking function (N3IWF) according to the related art.

For example, FIG. 2 (from [1]) indicates that the relay UE may have to either establish a new PDU session (at step 4) or modify an existing PDU session (at step 6) after a remote UE establishes a PC5 connection with the relay UE. But if the relay gets a BO timer at step 4 or step 6, then the relay UE will not be able to serve these UEs. Hence, maintaining the PC5 connections with the remote UE will not be beneficial and will in fact unnecessarily drain battery since maintaining the connection requires sending keep-alive messages which consume power for both the relay UE and the remote UEs.

2. Lack of Packet Filters that are Required for Serving Additional Remote UEs

The UE is required to support at least 16 packet filters (PFs) per PDU session over Uu reference point. However, if the UE supports more than that then the UE indicates, to the session management function (SMF), the number that it can support for the PDU session. The UE uses the maximum number of supported packet filters information element (IE) to report this number, when the number is larger than 16. As such, if the UE does not send this IE to the network (SMF), then the SMF assumes that the UE supports 16 packet filters only.

A problem that can arise is when a relay UE is currently serving a set of remote UEs such that the total number of packet filters per PDU session over Uu reference point that are supported by the relay UE has been reached for the required relay operations. If a new remote UE attempts to use the relay UE, then this relay UE will not be able to serve the remote UE due to lack of “free” PFs on that PDU session unless the remote UE is associated with another PDU session over Uu reference point with spare PFs. Such a scenario is not yet handled and a solution is required to address it. Examples of the disclosure provide solutions for addressing this scenario.

3. Maximum Number of PDU Sessions Reached for the UE in the Public Land Mobile Network (PLMN)

The PLMN may not support all the number of PDU sessions as that supported by the protocol. The maximum number of PDU Sessions can affect the maximum number Remote UEs that a relay (e.g., a Layer-3 relay) can support. When the UE attempts to establish a new PDU session but the network does not allow it, then the network sends the 5G mobility management (5GMM) cause #65 “maximum number of PDU sessions reached”. In the case, when the relay UE is attempting to establish a new PDU session to serve a remote UE (see step 2 in FIG. 2), the network may not allow the session to be established due to the maximum number of PDU session being reached. This scenario is not yet handled and it is not clear how receiving the 5GMM cause value #65 will impact PC5 operations or procedures between the relay UE and the remote UEs.

Certain examples of the disclosure provide one or more solutions to the above problems. Certain examples of the disclosure are described below. The skilled person will appreciate that the techniques disclosed herein may be used in any suitable combination.

The skilled person will also appreciate that the techniques disclosed herein may be applied to 5GS (NR access) and EPS (evolved universal mobile telecommunications system (UMTS) terrestrial radio access (E-UTRA) access) in a similar manner, where similar NAS procedures are applicable, possibly with different NAS message names.

In the disclosure, the term “relay UE” may refer, for example, to either “Layer-3 5G ProSe UE-to-Network Relay UE” or “Layer-2 5G ProSe UE-to-Network Relay UE.”

Certain examples of the disclosure provide a method, for a first User Equipment (UE) in a network comprising the first UE and a second UE, wherein the first UE is configured to operate as a relay node between the second UE and the network, the method comprising: receiving, from the second UE, a first message to request establishment of a direct link between the second UE and the first UE; and if a certain condition is satisfied, sending, to the second UE a second message rejecting the request, wherein the condition comprises: (i) the request is for relaying, and (ii) congestion control is activated at the first UE.

In certain examples, the condition (i), instead of being “the request is for relaying”, may be: the request is for establishing a direct link. The direct link may be established for relaying.

In certain examples, the condition may further comprise: (iii) a Relay Service Code (RSC) included in the first message corresponds to a Data Network Name (DNN) and/or a network slice (S-NSSAI) for which the congestion control is activated.

In certain examples, the condition may further comprise: (iv) the first UE, to meet the request, needs to perform a Protocol Data Unit (PDU) session establishment procedure for the DNN and/or S-NSSAI, or a PDU session modification procedure for the DNN and/or S-NSSAI.

In certain examples, the congestion control may comprise running a first back-off timer.

In certain examples, the first back-off timer may be associated with a certain DNN and/or S-NSSAI.

In certain examples, the second message may include a back-off timer value that is greater than or equal to a remaining back-off timer value of the first back-off timer.

In certain examples, the second message may include a cause value (e.g., #13) indicating “congestion situation.”

In certain examples: the first UE may be a proximity services (ProSe) Layer-3 UE-to-network relay UE; the direct link may be a 5G ProSe direct link; the first message may be a PROSE DIRECT LINK ESTABLISHMENT REQUEST message; the second message may be a PROSE DIRECT LINK ESTABLISHMENT REJECT message; the congestion control may be Non-Access Stratum (NAS) level session management congestion; and/or the cause value may be a PC5 signalling protocol cause value.

Certain examples of the disclosure provide a method, for a first UE in a network comprising the first UE and a second UE, wherein the first UE is configured to operate as a relay node between the second UE and the network, the method comprising: receiving, from the second UE, a first message to request modification of a direct link between the second UE and the first UE; and if a certain condition is satisfied, sending, to the second UE a second message rejecting the request, wherein the condition comprises: the first UE cannot support the addition of one or more packet filters required to perform a link modification operation for satisfying the request.

In certain examples, the request may comprise a request to add one or more new PC5 quality of service (QoS) flows to the link.

In certain examples, the condition may further comprise: the link modification procedure requires the addition of one or more new PC5 QoS flows and the first UE cannot support the one or more additional packet filters which would be required on an existing protocol data unit (PDU) session of the first UE.

In certain examples, the condition may further comprise: the request requires one or more new service data flows to be established on a link between the first UE and the network, and the first UE cannot support the one or more additional packet filters which would be required to be created for an existing PDU session of the first UE.

In certain examples, the first UE may not support the addition of the one or more packet filters if a maximum number of supported packet filters has been used.

In certain examples, the second message may include a cause value indicating “lack of local capabilities.”

In certain examples: the first UE may be a ProSe Layer-3 UE-to-network relay UE; the direct link may be a 5G ProSe direct link; the first message may be a PROSE DIRECT LINK MODIFICATION REQUEST message, the second message may be a PROSE DIRECT LINK MODIFICATION REJECT message, and/or the cause value may be a PC5 signalling protocol cause value.

Certain examples of the disclosure provide a method, for a first UE in a network comprising the first UE and a second UE, wherein the first UE is configured to operate as a relay node between the second UE and the network, the method comprising: receiving, from the second UE, a first message to request establishment of a direct link between the second UE and the first UE; and if a certain condition is satisfied, sending, to the second UE a second message rejecting the request, wherein the condition comprises: (i) the request is for relaying, and (ii) the request required the establishment of a PDU session by the first UE and the PDU session establishment was unsuccessful.

In certain examples, the condition (i), instead of being “the request is for relaying”, may be: the request is for establishing a direct link. The direct link may be established for relaying.

In certain examples, the condition may comprise: the PDU session establishment was unsuccessful due to receiving one or more predetermined cause values when the PDU session establishment was unsuccessful.

In certain examples, the one or more cause values may comprise one or more of: a cause value (e.g., #8) indicating “maximum number of PDU sessions reached”; a cause value (e.g., #27) indicating “Missing or unknown DNN”; a cause value (e.g., #28) indicating “Unknown PDU session type”; a cause value (e.g., #29) indicating “user authentication or authorization failed”; a cause value (e.g., #31) indicating “request rejected, unspecified”; a cause value (e.g., #32) indicating “service option not supported”; a cause value (e.g., #33) indicating “requested service option not subscribed”; and a cause value (e.g., #65) indicating “maximum number of PDU sessions reached.”

In certain examples, the second message may include a cause value (e.g., #111) indicating “protocol error, unspecified.”

In certain examples, the second message may include a back-off time value indicating a period of time for which the second UE should not retry the request again.

In certain examples, the PDU session may comprise a PDU session towards the network.

In certain examples: the first UE may be a Proximity Services (ProSe) Layer-3 UE-to-network relay UE; the direct link is a 5G ProSe direct link, the first message may be a PROSE DIRECT LINK ESTABLISHMENT REQUEST message, the second message may be a PROSE DIRECT LINK ESTABLISHMENT REJECT message, and/or the cause value may be a PC5 signalling protocol cause value.

Certain examples of the disclosure provide an apparatus (e.g., a UE) configured to perform a method according to any aspect, example, claim or embodiment disclosed herein.

Certain examples of the disclosure provide a network (or wireless communication system) comprising a first UE according to any aspect, example, claim or embodiment disclosed herein, and a second UE, wherein the first UE is configured to operate as a relay node between the second UE and the network.

Certain examples of the disclosure provide a computer program comprising instructions which, when the program is executed by a computer or processor, cause the computer or processor to carry out a method according to any aspect, example, claim or embodiment disclosed herein.

Certain examples of the disclosure provide a computer or processor-readable data carrier having stored there on a computer program according to any aspect, example, claim or embodiment disclosed herein.

1. Releasing PC5 Connections, and/or Rejecting New Connections, when a 5GSM BO Timer is Running but Only for Specific Remote UEs

In certain examples of the disclosure, when the relay UE starts a 5GSM BO timer (e.g., T3396, T3584, or T3585), then the relay UE should release the PC5 link that has been established with remote UEs. In an alternative, the relay UE should determine a set of remote UEs for which the PC5 connection needs to be released. To make this determination, the relay UE should verify which remote UEs (i.e., at least one) is being served by the PDU session for which any of the 5GSM BO timer has been started. Once these remote UEs are determined as described, then the relay UE should initiate the release of the PC5 link with the identified remote UEs. Furthermore, the relay UE should release the PC5 connections with the remote UEs (as described) regardless of whether the relay UE is in 5GMM-CONNECTED mode, 5GMM-IDLE mode, or 5GMM-CONNECTED mode with radio resource control (RRC) inactive indication. As such, the release of the PC5 connections with the remote UEs need not require that the relay UE is in 5GMM-IDLE mode. In an example, the relay UE may release the PC5 connection only if there is no user plane that is established with the network (i.e., on the Uu interface) for the PDU session which corresponds to, or which is associated with, or which is being use for, the PC5 links with the (at least one) remote UE(s), or the relay UE may only release a PC5 link if there is no user plane (or user data) that is being sent on the PC5 link which corresponds to (as described herein) the PDU session for which a 5GSM BO timer is running/has been started. As such, when the relay UE determines to possibly release a PC5 link with at least one remote UE, the relay UE may only do so if there are no active user plane resources on the Uu interface which corresponds to the remote UE in question or which corresponds to the PC5 link for the remote UE in question. Therefore, in certain examples, a PC5 link may only be released (as described above) if there is no data that is being exchanged on that PC5 link, or if the PC5 link is not being used for PC5 communication.

When releasing the PC5 connection with a remote UE, the relay UE should provide a PC5-level BO timer to each remote UE for which the PC5 connection is to be released. This PC5-level BO timer is to back-off the remote UE such that it should not attempt to establish a PC5 connection with the relay UE until the BO timer expires.

The relay UE should provide a PC5-level BO timer (i.e., for the PC5 link) to the remote UE such that the value of the BO timer is set to be at least the length of the largest remaining value of the 5GSM BO timer over Uu reference point. For example, assume the relay UE has a timer running for a first BO timer, e.g., T3396 (related to Uu reference point), and another timer for a second BO timer, e.g., T3585 (related to Uu reference point). Assume further that the remaining value of T3585 is larger than the remaining value of T3396. Then, when sending PC5-level BO timer to the remote UE for the PC5 connection/link, then the relay UE should set the BO timer on the PC5 link to be at least the length of T3585 (related to Uu reference point). The skilled person will appreciate that the disclosure is not limited to the above example.

As an example for the purpose of describing solutions, assume that a relay UE is serving remote UE #1 and remote UE #2 on a PDU session with identity X, and remote UE #3 and remote UE #4 on a PDU session with identity Y. Assume further that the relay UE starts a 5GSM BO timer over Uu reference point that is associated with PDU session Y (i.e., the BO timer was received using 5GSM signalling messages that are associated with PDU session identity Y), and/or that is associated with a slice (S-NSSAI) or a DNN or a slice/DNN combination. In accordance with certain examples of the disclosure, the relay identifies remote UE #3 and remote UE #4 as the ones for which the PC5 connection should be released as they are served by the PDU session (with identity Y) with an initiated 5GSM BO timer over Uu reference point. The skilled person will appreciate that the determination of the UEs that are affected may be as follows in various non-limiting examples: the relay UE identifies the remote UEs which are being served using a PDU session for which a 5GSM BO timer is running, where the remote UEs being served are served using a particular slice or DNN or slice/DNN combination for which an associated 5GSM BO timer is running/has been started. As such, the identification of the remote UEs may be based on the PDU session ID for which a 5GSM BO timer is running, or may be based on the slice or DNN or slice/DNN combination for which a 5GSM BO timer is running and which is being used by the relay UE on a PDU session that is established with the known slice or DNN or slice/DNN combination, for which a corresponding 5GSM BO timer is running/has been started.

After determining the target remote UEs as described, the relay UE should release the PC5 connection with the identified remote UEs. Optionally the relay UE provides a PC5-level BO timer to the remote UEs as part of the PC5 connection release procedure (e.g., when sending the PROSE DIRECT LINK RELEASE REQUEST message).

In certain examples, when the relay UE releases the PC5 connection due to the 5GSM BO timer over Uu reference point, the relay UE should include a cause value to indicate the reason for releasing the PC5 connection. This cause value may be new or may be existing. For example, the existing cause value #13 “congestion situation” (see [3]). Alternatively, a new cause code over PC5 can be defined and used explicitly for 5GSM congestion control, where the value may specifically indicate that the congestion situation is for 5GSM congestion over Uu reference point.

Additionally, the relay UE may stop performing the discovery procedure (e.g., the UE-to-network relay discovery procedure) optionally where the discovery procedure to be stopped should be that for a particular relay service code (RSC) which is associated with the PDU session identity for which a 5GSM BO timer over Uu reference point is running, or the RSC that is associated with the slice and/or DNN for which the 5GSM BO timer over Uu reference point is also associated with and for which the 5GSM BO timer over Uu reference point is running. As such, in certain examples, the relay UE does not stop all the PC5 discovery procedures but rather stops the procedures that are related to the PDU session for which a 5GSM BO timer over Uu reference point is running, or that are related to the slice and/or DNN for which a 5GSM BO timer over Uu reference point is running.

The relay may still perform discovery procedure over an RSC described above if it is also associated to PDU session identities without 5GSM BO timers running (i.e., non-congested Uu-level PDU session identities). The relay UE may still serve remote UEs associated with non-congested Uu-level PDU session identities as normal.

The skilled person will appreciate that the techniques described above may also be applicable to the case that the relay UE receives a request for a new PC5 link connection, optionally where the link operation is to add a new QoS flow. For example, the relay UE may have a BO timer running, where this may be a mobility management BO timer or a session management BO timer as described above. While the timer is running, the relay UE may get a new request from a remote UE to establish a PC5 link, optionally where the link operation is to add a new QoS flow. Accordingly, in certain examples, the relay UE may reject the request due to the presence of a running BO timer which may be for mobility management congestion control or session management congestion control, for example as described above. For the case of the session management BO timer, the relay UE may optionally reject the request if the request is associated with any parameter, e.g., DNN, S-NSSAI, RSC, or the like, which is in turn associated with the running BO timer. For example, if the new request is for a PC5 connection which is known to use a specific slice (and/or DNN) for which the relay UE has a running BO timer, then the relay UE determines that this is not possible and hence should reject the request. The relay UE may include a BO timer and/or a PC5 cause value in the PC5 response message (e.g., the PC5 message that is used to reject the request), where the PC5 cause value may be any existing value or a new value. However, if the request is not related to the running session management BO timer, e.g., the request is associated with e.g., a DNN, S-NSSAI, RSC, or the like, where none (any or all) of these parameters are associated with the BO timer, then the relay UE may grant the request and not necessarily reject it.

For example, one or more of the following techniques may be applied to define certain behaviour for a relay UE, for example based on one or more of the techniques described above.

If the 5G ProSe direct link establishment request is for relaying, the NAS level session management congestion, for example as specified in clause 6.2.7 and in clause 6.2.8 of TS 24.501, may be activated at the target UE (e.g., the corresponding 5GSM BO timer is running) which is acting as a 5G ProSe layer-3 UE-to-network relay UE, the relay service code used in the 5G ProSe direct link establishment corresponds to a DNN and/or S-NSSAI for which the NAS level session management congestion is activated, and the target UE may need to perform the PDU session establishment for the DNN and/or S-NSSAI or the PDU session modification procedure for the DNN and/or S-NSSAI to support the initiating UE, then the target UE may send a message (e.g., PROSE DIRECT LINK ESTABLISHMENT REJECT message) containing a suitable PC5 signalling protocol cause value, for example #13 “congestion situation”. The target UE may provide a back-off timer value to the initiating UE in the message (e.g., PROSE DIRECT LINK ESTABLISHMENT REJECT message).

The skilled person will appreciate that, for any of the techniques disclosed herein, the relay UE may optionally verify if any PC5 link request (i.e., to establish a new link or to modify an existing link) may require any 5GSM procedure towards the network for a DNN and/or slice (or may require sending any 5GSM message to the network or may require initiating any 5GSM procedure with the network). If required, and if a 5GSM BO timer is running for the DNN and/or slice, then the relay UE may be configured to behave as described herein, for example the relay UE may be configured to reject the request on PC5 link (i.e., request to either establish a new PC5 link or modify an existing PC5 link).

In various examples of the disclosure, the relay UE may be configured to operate according to any technique disclosed herein using any suitable order of actions and in any suitable combination. For example, the UE may check for any suitable combination of conditions in any suitable order. In addition, the relay UE may take any suitable combination of actions disclosed herein and in any suitable order.

The skilled person will appreciate that the various examples of the disclosure can also apply to a remote UE which is using a Layer 2 (L2)-relay UE, as will be described below.

As such, in certain examples, when a remote UE (which is using a L2-relay UE) receives a mobility management BO timer, or when the remote UE (which is using a L2-relay UE) starts a mobility management BO timer, the remote UE should release its PC5 link with the relay UE, optionally after entering 5GMM-IDLE mode. Alternatively, when a remote UE (which is using a L2-relay UE) receives a mobility management BO timer, or when the remote UE (which is using a L2-relay UE) starts a mobility management BO timer, the remote UE may release its PC5 link with the relay UE if there is no ongoing user plane exchange over the PC5 link (i.e., if there is no active PC5 communication). The remote UE should not initiate a PC5 link establishment with a Layer-2 relay UE while a mobility management BO timer is running. The remote UE can stop the mobility management BO timer when it receives a paging message from the network, where the paging message is received over a PC5 message optionally via a Layer-relay UE. When the mobility management BO timer expires in the remote UE, or when the mobility management BO timer is stopped, then the remote UE can initiate the establishment of a PC5 link with a Layer-2 remote UE. The start of a mobility management BO timer should not lead to a reselection of a Layer-2 relay UE, however, the remote UE may reselect to a Layer-3 relay UE.

In an alternative example, if the remote UE (which is using a L2-relay UE) receives a mobility management BO timer, or starts a mobility management BO timer, while there is ongoing user-plane exchange with the network (e.g., via the Layer-2 relay UE), then the remote UE need not release the PC5 link and may continue sending user plane data, however no mobility management signalling may be sent by the remote UE.

Now considering the session management BO timer or congestion control. In certain examples, the same behaviour as described above for mobility management BO timer can optionally apply to session management BO timer. However, a difference is that the remote UE (which is using a L2-relay UE) can still establish a PC5 link/connection even when a session management BO timer is running if the reason to do so is not related to the PDU session (or sessions management parameters e.g., S-NSSAI and/or DNN) for which the session management BO timer is running. As such, if the UE has mobility management procedures to perform, or session management procedures to initiate (where the procedures are associated with session management parameters that are not related to the running session management BO timer) for other reasons not related to the running session management BO timer, then the remote UE can initiate a PC5 link establishment and send the necessary signalling or initiate the necessary procedure with the network (via the L2-relay UE).

In one example, when the remote UE (which is using a L2-relay UE) starts a session management BO timer, then the remote UE should release its PC5 connection only if it has only one PDU session for which the BO timer is running, or for which the running BO timer is associated with the session parameters (e.g., S-NSSAI and/or DNN). As such, if the UE has other PDU sessions that are established, or if the UE is sending user plane data (even for the congestion PDU session), then the remote UE need not release its PC5 link with the L2-relay UE.

For all the techniques described above regarding a remote UE proposal to release its PC5 link due to a congestion (mobility management or session management BO timer running), in certain examples the remote UE may release its PC5 link/connection if it is in 5GMM-IDLE mode.

If the remote UE releases its PC5 link as described above, then the remote UE can initiate the PC5 link establishment with the remote UE if the session management BO timer expires or if the timer is stopped, where the remote UE can stop the timer if it receives any terminated session management message from the network where the message is receives over a PC5 message optionally from a L2-relay UE.

2. UE Behavior when the Maximum Number of Supported Packet Filters has been all Used

The following examples addresses at least the following two cases:

The relay UE gets a new request to add at least one new PC5 QoS flow to an existing 5G ProSe direct link, where the request is from a remote UE which is currently being served by the relay UE (i.e., there is at least one current PC5 QoS flow on an existing 5G ProSe direct link between the remote UE in question and the relay UE), or

The relay UE gets new request to establish a new 5G ProSe direct link from a remote UE

Solutions to Address Case 1

When a relay UE receives a request to add at least one new PC5 QoS flow to an existing 5G ProSe direct link, the relay should verify if the request requires a new service data flow to be established on the Uu link (i.e., between the relay UE and the network over the Uu link). If a new service data flow is required such that a new set of packet filters (PFs) is also required to be created for an existing PDU session, the relay UE should further verify if the maximum number of supported packet filters, for the existing PDU session, has been used or not. If all the PFs for the existing PDU session have been used and the relay UE cannot support more than the number that is currently being used over an existing PDU session, or if the maximum number of supported PFs is already being used over an existing PDU session (and hence no additional PF can be used/supported), then the relay UE should reject the addition of the new PC5 QoS flow, where the rejection is optionally performed by the relay UE if it cannot establish any new PDU sessions over Uu.

Alternatively, the UE may establish a new PDU session to support the new PC5 QoS flow if the UE can indeed support a new PDU session but cannot support additional PFs on the current PDU session. In this case, the relay UE need not reject the request from the remote UE.

To reject the addition of a new PC5 QoS flow, the relay UE may send a new PC5 message, or may send the PROSE DIRECT LINK MODIFICATION REJECT message to the remote UE (or to the initiating UE). The relay UE may indicate the reason for rejection, where the reason may be indicated using a new cause code (e.g., a new PC5 signalling protocol cause IE) indicating that there are no 5GSM resources or capabilities over the Uu interface (reference point). Note that the value of this new cause may be defined to be any new value e.g., “lack of PFs,” or the like. Alternatively, an existing value can be used for the PC5 signalling protocol cause IE e.g., #5, or #6 as defined in [3].

The relay UE may be the target UE as defined in [3], and the remote UE may be the initiating UE as defined in [3]. However vice versa may also be possible.

Optionally, when the relay UE determines that the maximum number of PFs per PDU session that is supported has been used, then the relay UE may stop performing PC5 discovery procedures related to the PDU session (for which the maximum number of supported PFs has been used). Optionally, the relay UE may stop performing PC5 discovery procedures for the RSC that is associated with the PDU session for which the maximum number of PFs has been used. The relay UE may resume the discovery procedure when the number of PFs being used for the PDU session is less than the maximum number of PFs that the UE can support for the PDU session.

The relay may still perform discovery procedure over an RSC described above if it is also associated to PDU session identities, not reaching the maximum number of PFs. The relay UE may still serve remote UEs associated with PDU session identities that do not reach the maximum number of PFs as normal.

In certain examples of the disclosure, receiving (e.g., by the relay UE) a request to add a new PC5 QoS flow may be interpreted as receiving (e.g., by the relay UE) the PROSE DIRECT LINK MODIFICATION REQUEST message with the PC5 QoS rules IE and the rule operation in the IE indicates “Create new PC5 QoS rule” as defined in [3].

Solutions to Address Case 2

When a relay UE receives a request to establish a new 5G ProSe direct link and the request also requires the addition/creation of at least one new PC5 QoS flow, the relay should verify if the request requires a new service data flow to be established on the Uu link (i.e., between the relay UE and the network over the Uu link). If a new service data flow is required such that a new set of packet filters (PFs) per existing PDU session is also required to be created, the relay UE should further verify if the maximum number of supported packet filters per PDU session has been used or not. If all the PFs per PDU session have been used and the relay UE cannot support more than the number that is currently being used over existing an PDU session, or if the maximum number of supported PFs is already being used over an existing PDU session (and hence no additional PF can be used/supported), then the relay UE should reject the establishment of the new 5G ProSe direct link, where the rejection is optionally performed by the relay UE, where the rejection is optionally performed by the relay UE if it cannot establish any new PDU sessions over Uu.

Alternatively, the UE may establish a new PDU session to support the new PC5 QoS flow if the UE can indeed support a new PDU session but cannot support additional PFs on the current PDU session. In this case, the relay UE need not reject the request from the remote UE.

To reject the request as described above, the relay UE may send a new PC5 message, or may send the PROSE DIRECT LINK ESTABLISHMENT REJECT message to the remote UE (or to the initiating UE). The relay UE may indicate the reason for rejection, where the reason may be indicated using a new cause code (e.g., a new PC5 signalling protocol cause IE) indicating that there are no 5GSM resources or capabilities over the Uu interface (reference point). The value of this new cause may be defined to be any new value, e.g., “lack of PFs”, or the like. Alternatively, an existing value can be used for the PC5 signalling protocol cause IE, e.g., #5, or #6 as defined in [3].

Optionally, when the relay UE determines that the maximum number of PFs per PDU session that is supported has been used, then the relay UE may stop performing PC5 discovery procedures related to the PDU session (for which the maximum number of supported PFs has been used). Optionally, the relay UE may stop performing PC5 discovery procedures for the RSC that is associated with the PDU session for which the maximum number of PFs has been used. The relay UE may resume the discovery procedure (optionally for the related RSC) when the number of PFs being used for the PDU session is less than the maximum number of PFs that the UE can support for the PDU session.

The relay may still perform discovery procedure over an RSC described above if it is also associated to PDU session identities, not reaching the maximum number of PFs. The relay UE may still serve remote UEs associated with PDU session identities that do not reach the maximum number of PFs as normal.

3. UE Behavior when the Maximum Number of PDU Sessions has been Reached (as Indicated by the Network)

When a relay UE receives a request on the PC5 link (e.g., a request to modify an existing 5G ProSe direct link, or a request to establish a new 5G ProSe direct link) and the relay UE determines that a new PDU session is required, then the relay UE may attempt to establish a new PDU session towards the network. However, if the relay UE's attempt to establish a new PDU session is unsuccessful and the relay UE receives the #65 “maximum number of PDU sessions reached” (e.g., where this 5GMM cause value is received in a downlink (DL) NAS TRANSPORT message with a 5GSM message which was not forwarded as described in [2]), then the relay UE should reject the establishment of the new PC5 link if it has not been established yet (e.g., by sending the PROSE DIRECT LINK ESTABLISHMENT REJECT message to the remote UE). However, if the link has already been established, then the relay UE should initiate the PC5 link release procedure (e.g., by sending the PROSE DIRECT LINK RELEASE REQUEST message) and optionally indicate a cause value for the reason of the release (e.g., by including the PC5 signalling protocol cause IE, where this IE may be set to indicate any of the existing values as defined in [3], e.g., #13, or a new value may be defined to indicate that a new PDU session cannot be established with the network). The relay UE may include a PC5-level BO timer to indicate a period of time for which the remote UE should not retry the request again.

The skilled person will appreciate that the techniques described above may also apply in the case when the UE has determined that no additional PDU session can be established, for example due to a maximum number of PDU sessions that the protocol supports. For example, if the relay UE knows that the protocol supports 15 PDU sessions as a maximum, and the relay UE already has this number of maximum PDU sessions that are active, then any PC5 request from a remote UE which requires a new PDU session to be established may be rejected by the relay UE, where the relay UE determines that no additional PDU session can be established. Therefore, the techniques disclosed above may apply in the case when: the network informs the relay UE that the maximum number of PDU session has been reached, and/or when the relay UE makes this determination using any suitable technique such as, but not limited to, the maximum number of PDU sessions that is supported by the protocol and the relay UE has indeed established this maximum number of PDU sessions.

Optionally, when the relay UE determines that the maximum number PDU sessions has been reached (as described above), then the relay UE may stop performing PC5 discovery for RSCs that cannot be associated with any existing PDU sessions or for RSCs for which procedures related to the PDU session which was not successfully established. Optionally, the relay UE may stop performing PC5 discovery procedures for the RSC that is associated with the PDU session which was not successfully established. The relay UE may resume the discovery procedure (optionally for the related RSCs that cannot be associated with any existing PDU sessions) when the relay UE determines that the number of PDU sessions being used at any time is less than the maximum number of PDU sessions that was reached (or that is supported/allowed by the network for the UE, for example as described in [2]).

The skilled person will appreciate that the techniques described above may be applied to any case in which the relay UE attempts to establish a PDU session but the attempt is unsuccessful, for example where the reason may be due to a temporary error/issue, or due to a longer term error/issue, as per the 5GSM cause value that is received from the network. Hence the techniques described above may be applied to any case in which the PDU session that is required cannot be successfully established for any reason, where the reason is not necessarily related to the network indicating that the maximum number of PDU session has been reached.

Furthermore, the techniques described above may be applied even when the 5GSM layer or 5GSM entity does not directly receive the necessary cause value from the SMF, but where the 5GSM layer may actually receive the cause value from the 5GMM layer. For example, the techniques described above may be applied even when the 5GSM receives the value #65 “maximum number of PDU sessions reached” from the 5GMM entity. As such, the same general techniques or behaviour may be applied for any other case in which the PDU session establishment is unsuccessful, and optionally for which the 5GSM entity receives a cause value from the 5GMM entity (and not necessarily from the SMF directly). In these cases, the techniques described above may also be applied.

For all of the cases identified above, e.g., for any case that the relay UE attempts to establish a PDU session but the attempt is unsuccessful, the relay UE may optionally stop the related PC5 discovery procedures for the related RSC or S-NSSAI or DNN, or any combination.

Furthermore, the proposals above an also be applicable to a layer-2 remote UE. For example, if the remote UE attempts to establish a PDU session and the PDU session establishment procedure is unsuccessful, regardless of the cause value or whether it is received from the SMF or from the 5GMM entity, then the remote UE may release its PC5 link with the layer-2 relay UE. In one option, the layer-2 remote UE may release its PC5 link with the layer-2 remote UE only if there is no other active PC5 connection with the relay UE i.e., only when there is no data or signalling that the layer-2 remote UE is exchanging with the network via the layer-2 relay UE which would then mean that the PC5 link is actively being used.

In general, for all the proposals herein, the same proposals may apply to more than one node such as a layer-2 remote UE, layer-3 remote UE, layer-2 relay UE, layer-3 relay UE. As such, even if the proposal is provided with a specific node that is explicitly mentioned, the proposals should not be deemed to be restricted to the one node that is explicitly mentioned and as such may be applied for other nodes as well. The proposals can apply in any order or combination.

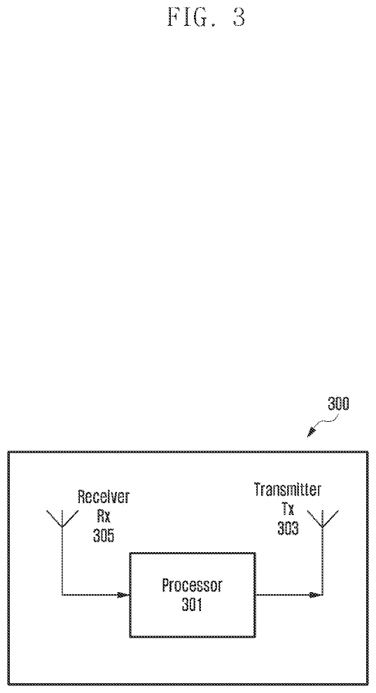

FIG. 3 is a block diagram of a network entity that may be used in according to an embodiment of the disclosure, including the examples disclosed in relation to FIGS. 1 and 2. For example, a UE, relay, next generation (NG)-radio access network (RAN), AMF, SMF, user plane function (UPF) and/or other network function (NF)s may be provided in the form of the network entity illustrated in FIG. 3.

The skilled person will appreciate that a network entity, including the network entity illustrated in FIG. 3, may be implemented, for example, as a network element on a dedicated hardware, as a software instance running on a dedicated hardware, or as a virtualised function instantiated on an appropriate platform, e.g., on a cloud infrastructure.

The entity 300 comprises a processor (or controller) 301, a transmitter 303 and a receiver 305. The receiver 305 is configured for receiving one or more messages or signals from one or more other network entities. The transmitter 303 is configured for transmitting one or more messages or signals to one or more other network entities. The processor 301 is configured for performing one or more operations and/or functions as described above.

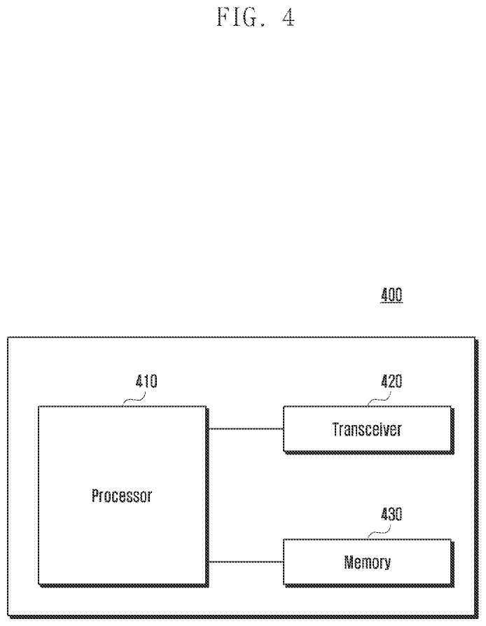

FIG. 4 illustrates an electronic device according to an embodiment of the disclosure.

Referring to FIG. 4, the electronic device 400 may include a processor 410, a transceiver 420 and a memory 430. However, all of the illustrated components are not essential. The electronic device 400 may be implemented by more or less components than those illustrated in FIG. 4. In addition, the processor 410 and the transceiver 420 and the memory 430 may be implemented as a single chip according to another embodiment.

The electronic device 400 may correspond to the UE described above.

The aforementioned components will now be described below.

The processor 410 may include one or more processors or other processing devices that control the proposed function, process, and/or method. Operation of the electronic device 400 may be implemented by the processor 410.

The transceiver 420 may include a RF transmitter for up-converting and amplifying a transmitted signal, and a RF receiver for down-converting a frequency of a received signal. However, according to another embodiment, the transceiver 420 may be implemented by more or less components than those illustrated in components.

The transceiver 420 may be connected to the processor 410 and transmit and/or receive a signal. The signal may include control information and data. In addition, the transceiver 420 may receive the signal through a wireless channel and output the signal to the processor 410. The transceiver 420 may transmit a signal output from the processor 410 through the wireless channel.

The memory 430 may store the control information or the data included in a signal obtained by the electronic device 400. The memory 430 may be connected to the processor 410 and store at least one instruction or a protocol or a parameter for the proposed function, process, and/or method. The memory 430 may include a read-only memory (ROM) and/or a random access memory (RAM) and/or a hard disk and/or a compact disc (CD)-ROM and/or a digital versatile disc (DVD) and/or other storage devices.

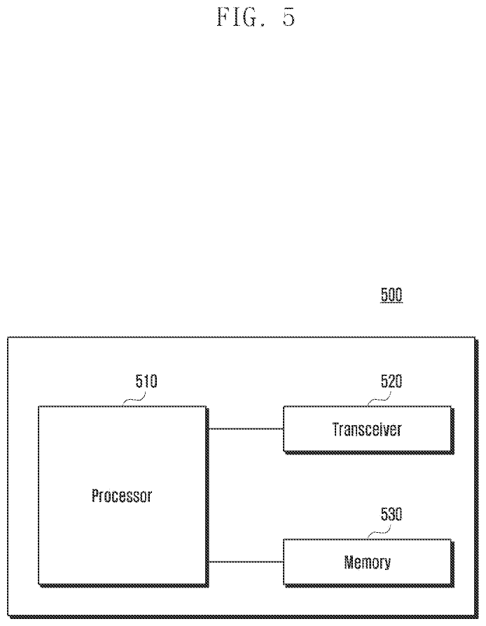

FIG. 5 illustrates a node according to an embodiment of the disclosure.

Referring to FIG. 5, the node 500 may include a processor 510, a transceiver 520 and a memory 530. However, all of the illustrated components are not essential. The node 500 may be implemented by more or less components than those illustrated in FIG. 5. In addition, the processor 510 and the transceiver 520 and the memory 530 may be implemented as a single chip according to another embodiment.

The node 500 may correspond to the NG-RAN, AMF, SMF, UPF, other NFs, and/or network entity described above.

The aforementioned components will now be described below.

The processor 510 may include one or more processors or other processing devices that control the proposed function, process, and/or method. Operation of the node 500 may be implemented by the processor 510.

The transceiver 520 may include a RF transmitter for up-converting and amplifying a transmitted signal, and a RF receiver for down-converting a frequency of a received signal. However, according to another embodiment, the transceiver 520 may be implemented by more or less components than those illustrated in components.

The transceiver 520 may be connected to the processor 510 and transmit and/or receive a signal. The signal may include control information and data. In addition, the transceiver 520 may receive the signal through a wireless channel and output the signal to the processor 510. The transceiver 520 may transmit a signal output from the processor 510 through the wireless channel.

The memory 530 may store the control information or the data included in a signal obtained by the node 500. The memory 530 may be connected to the processor 510 and store at least one instruction or a protocol or a parameter for the proposed function, process, and/or method. The memory 530 may include a read-only memory (ROM) and/or a random access memory (RAM) and/or a hard disk and/or a CD-ROM and/or DVD and/or other storage devices.

The techniques described herein may be implemented using any suitably configured apparatus and/or system. Such an apparatus and/or system may be configured to perform a method according to any aspect, embodiment, example or claim disclosed herein. Such an apparatus may comprise one or more elements, for example one or more of receivers, transmitters, transceivers, processors, controllers, modules, units, and the like, each element configured to perform one or more corresponding processes, operations and/or method steps for implementing the techniques described herein. For example, an operation/function of X may be performed by a module configured to perform X (or an X-module). The one or more elements may be implemented in the form of hardware, software, or any combination of hardware and software.

It will be appreciated that examples of the disclosure may be implemented in the form of hardware, software or any combination of hardware and software. Any such software may be stored in the form of volatile or non-volatile storage, for example a storage device like a ROM, whether erasable or rewritable or not, or in the form of memory such as, for example, RAM, memory chips, device or integrated circuits or on an optically or magnetically readable medium such as, for example, a CD, DVD, magnetic disk or magnetic tape or the like.

It will be appreciated that the storage devices and storage media are embodiments of machine-readable storage that are suitable for storing a program or programs comprising instructions that, when executed, implement certain examples of the disclosure. Accordingly, certain example provides a program comprising code for implementing a method, apparatus or system according to any example, embodiment, aspect and/or claim disclosed herein, and/or a machine-readable storage storing such a program. Still further, such programs may be conveyed electronically via any medium, for example a communication signal carried over a wired or wireless connection.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A method performed by a first user equipment (UE) in a network, the method comprising:
receiving, from a second UE in the network, a first message to request establishment of a direct link between the second UE and the first UE, wherein the first UE is configured to operate as a relay node between the second UE and the network; and
in cast that a certain condition is satisfied, sending, to the second UE, a second message rejecting the request,
wherein the certain condition comprises:
the request is for relaying, and
congestion control is activated at the first UE.

2. The method of claim 1, wherein the certain condition further comprises at least one of:
a relay service code (RSC) included in the first message corresponds to at least one of a data network name (DNN) or a network slice (S-NSSAI) for which the congestion control is activated; or
the first UE, to meet the request, needs to perform a protocol data unit (PDU) session establishment procedure for at least one of the DNN or the S-NSSAI, or a PDU session modification procedure for the at least one of the DNN or the S-NSSAI.

3. The method of claim 1, wherein the congestion control comprises running a first back-off timer.

4. The method of claim 3, wherein the first back-off timer is associated with at least one of a certain data network name (DNN) or a certain network slice (S-NSSAI).

5. The method of claim 3, wherein the second message includes a back-off timer value that is greater than or equal to a remaining back-off timer value of the first back-off timer.

6. The method of claim 1, wherein the second message includes a cause value indicating “congestion situation.”

7. The method of claim 6, wherein at least one of the below is satisfied that:
the first UE is a proximity services (ProSe) Layer-3 UE-to-network relay UE;
the direct link is a 5G ProSe direct link;
the first message is a PROSE DIRECT LINK ESTABLISHMENT REQUEST message;
the second message is a PROSE DIRECT LINK ESTABLISHMENT REJECT message;
the congestion control is non access stratum (NAS) level session management congestion; or
the cause value is a PC5 signalling protocol cause value.

8. A method performed by a first user equipment (UE) in a network, the method comprising:
receiving, from a second UE in the network, a first message to request modification of a direct link between the second UE and the first UE, wherein the first UE is configured to operate as a relay node between the second UE and the network; and
in case that a certain condition is satisfied, sending, to the second UE, a second message rejecting the request,
wherein the certain condition comprises:
the first UE cannot support addition of one or more packet filters required to perform a link modification operation for satisfying the request.

9. The method of claim 8, wherein the request comprises a request to add one or more new PC5 quality of service (QoS) flows to the link.

10. The method of claim 9, wherein the certain condition further comprises:
a link modification procedure requires the addition of one or more new PC5 QoS flows; and
the first UE cannot support the one or more additional packet filters which would be required on an existing protocol data unit (PDU) session of the first UE.

11. The method of claim 10, wherein the certain condition further comprises:
the request requires one or more new service data flows to be established on a link between the first UE and the network; and
the first UE cannot support the one or more additional packet filters which would be required to be created for an existing PDU session of the first UE.

12. The method of claim 11, wherein the first UE cannot support the addition of the one or more packet filters if a maximum number of supported packet filters has been used.

13. The method of claim 8, wherein the second message includes a cause value indicating “lack of local capabilities.”

14. The method of claim 13, wherein at least one of the below is satisfied that:
the first UE is a proximity services (ProSe) layer-3 UE-to-network relay UE;
the direct link is a 5G ProSe direct link;
the first message is a PROSE DIRECT LINK MODIFICATION REQUEST message;
the second message is a PROSE DIRECT LINK MODIFICATION REJECT message; or
the cause value is a PC5 signalling protocol cause value.

15. A method performed by a first user equipment (UE) in a network, the method comprising:
receiving, from a second UE in the network, a first message to request establishment of a direct link between the second UE and the first UE, wherein the first UE is configured to operate as a relay node between the second UE and the network; and
in case that a certain condition is satisfied, sending, to the second UE, a second message rejecting the request,
wherein the certain condition comprises:
the request is for relaying, and
the request required the establishment of a protocol data unit (PDU) session by the first UE and the establishment of the PDU session was unsuccessful.

16. The method of claim 15, wherein the certain condition further comprises:
the PDU session establishment was unsuccessful due to receiving one or more predetermined cause values when the PDU session establishment was unsuccessful.

17. The method of claim 16, wherein the one or more cause values comprise one or more of:
a cause value indicating “maximum number of PDU sessions reached”;
a cause value indicating “Missing or unknown data network name (DNN)”;
a cause value indicating “Unknown PDU session type”;
a cause value indicating “user authentication or authorization failed”;
a cause value indicating “request rejected, unspecified”;
a cause value indicating “service option not supported”;
a cause value indicating “requested service option not subscribed”; or
a cause value indicating “maximum number of PDU sessions reached.”

18. The method of claim 15, wherein the second message includes a cause value indicating “protocol error, unspecified.”

19. The method of claim 18,
wherein the second message includes a back-off time value indicating a period of time for which the second UE should not retry the request again,
wherein the PDU session comprises a PDU session towards the network, and
wherein at least one of the below is satisfied that:
the first UE is a proximity services (ProSe) layer-3 UE-to-network relay UE,
the direct link is a 5G ProSe direct link,
the first message is a PROSE DIRECT LINK ESTABLISHMENT REQUEST message,
the second message is a PROSE DIRECT LINK ESTABLISHMENT REJECT message, or
the cause value is a PC5 signalling protocol cause value.

20. A first user equipment (UE) in a network, the first user equipment comprising:
a transceiver; and
a processor coupled with the transceiver and configured to:
receive, from a second UE in the network, a first message to request establishment of a direct link between the second UE and the first UE, wherein the first UE is configured to operate as a relay node between the second UE and the network, and
in cast that a certain condition is satisfied, send, to the second UE, a second message rejecting the request,
wherein the certain condition comprises:
the request is for relaying, and
congestion control is activated at the first UE.
